(19) United States
(12) Patent Application Publication
(10) Pub. No.: US 2024/0135143 A1
(43) Pub. Date: Apr. 25, 2024

(54) MODEL GENERATION SYSTEM, METHOD, AND PROGRAM

(71) Applicant: NEC Corporation, Minato-ku, tokyoyo (JP)

(72) Inventor: Makoto TAKAMOTO, Tokyo (JP)

(73) Assignee: NEC Corporation, Minato-ku, Tokyo (JP)

(21) Appl. No.: 17/769,614

(22) PCT Filed: Oct. 27, 2019
(86) PCT No.: PCT/JP2019/042152

§ 371 Date: Apr. 14, 2022

(51) Int. Cl. G06N 3/045

(52) U.S. Cl. CPC G06N 3/045

(57) ABSTRACT

A data generation unit 6 generates a first number of false data based on a generation model that is a neural network for generating false data. A discriminator unit 7 derives output values for given data based on a discriminator model that is a neural network for deriving output values indicating true data-likeness and false data-likeness of the given data. A gradient information calculation unit 8 calculates, for each combination of one true data and each of the first number of false data, a distance between the output value for the true data and the output value for the false data, and calculates gradient information that is an update amount for each weight that the discriminator model has, so as to increase the distance by a predetermined amount. A selection unit 9 selects false data to be stored in the saved data storage unit 4.

### TECHNICAL FIELD

The present invention relates to a model generation system, a model generation method, and a model generation program, and in particular to a model generation system, a model generation method, and a model generation program for generating a model in a generative adversarial network.

### BACKGROUND ART

The generative adversarial network uses a discriminator that discriminates whether given data is true data or false data, and a generator that generates false data. In the generative adversarial network, the generator is made to learn a model of the generator so that it generates false data that deceives the discriminator, and the discriminator is made to learn a model of the discriminator so that it improves the discrimination accuracy.

Newly generated false data by the generator is used to learn the model of the discriminator.

A generative adversarial network is described in, for example, Patent Literature 1.

Non-Patent Literature 1 also describes storing previously generated images in a generative adversarial network.

### CITATION LIST

### Patent Literature

PTL 1: Japanese Patent Application Laid-Open No. 2019-46390

### Non-Patent Literature

NPL 1: Ashish Shrivastava, and 5 others, “Learning from Simulated and Unsupervised Images through Adversarial Training,” [Retrieved Aug. 6, 2019], from the Internet <URL: Available from: https://arxiv.org/pdf/1612.07828.pdf>

### SUMMARY OF INVENTION

### Technical Problem

The generative adversarial network has a problem of unstable learning. Here, unstable learning means that learning does not always work.

The following are examples of unstable learning in the generative adversarial network.

The generator generates false data randomly to some extent. Therefore, the generator may begin to generate false data that is completely different from the previous data. In such a case, if the discriminator discriminates the false data as more likely to be true data than true data, or discriminates the false data as false data with very strong false data-like characteristics, the discriminator is penalized significantly. As a result, the model is learned that specifically discriminates the false data with high discrimination accuracy.

Therefore, it is an object of the present invention to provide a model generation system, a model generation method, and a model generation program capable of generating each model in a generative adversarial network satisfactorily (in other words, each model can be generated stably).

### Solution to Problem

A model generation system according to the present invention includes a saved data storage unit which stores false data to be stored, a data generation unit which generates a first number of false data based on a generation model that is a neural network for generating false data, a discriminator unit which derives output values for given data based on a discriminator model that is a neural network for deriving output values indicating true data-likeness and false data-likeness of the given data, a gradient information calculation unit which calculates, for each combination of one true data and each of the first number of false data, a distance between the output value for the true data and the output value for the false data, and calculates gradient information that is an update amount for each weight that the discriminator model has, so as to increase the distance by a predetermined amount, and a selection unit which selects false data to be stored in the saved data storage unit from among the first number of false data based on the gradient information for each weight calculated for each false data, and stores the selected false data in the saved data storage unit.

A model generation system according to the present invention includes a saved data storage unit which stores false data to be stored, a data generation unit which generates a first number of false data based on a generation model that is a neural network for generating false data, a discriminator unit which derives output values for given data based on a discriminator model that is a neural network for deriving output values indicating true data-likeness and false data-likeness of the given data, a distance calculation unit which calculates, for each combination of one true data and each of the first number of false data, a distance between the output value for the true data and the output value for the false data, and a selection unit which selects false data to be stored in the saved data storage unit from among the first number of false data based on the distance calculated for each false data, and stores the selected false data in the saved data storage unit.

A model generation method according to the present invention, implemented by a computer, includes generating a first number of false data based on a generation model that is a neural network for generating false data, deriving output values for given data based on a discriminator model that is a neural network for deriving output values indicating true data-likeness and false data-likeness of the given data, calculating, for each combination of one true data and each of the first number of false data, a distance between the output value for the true data and the output value for the false data, and calculating gradient information that is an update amount for each weight that the discriminator model has, so as to increase the distance by a predetermined amount, and selecting false data to be stored in the saved data storage unit, which stores false data to be stored, from among the first number of false data based on the gradient information for each weight calculated for each false data, and storing the selected false data in the saved data storage unit.

A model generation method according to the present invention, implemented by a computer, includes generating a first number of false data based on a generation model that is a neural network for generating false data, deriving output values for given data based on a discriminator model that is a neural network for deriving output values indicating true data-likeness and false data-likeness of the given data, calculating, for each combination of one true data and each of the first number of false data, a distance between the output value for the true data and the output value for the false data, and selecting false data to be stored in the saved data storage unit, which stores false data to be stored, from among the first number of false data based on the distance calculated for each false data, and storing the selected false data in the saved data storage unit.

A model generation program according to the present invention, that allows a computer to function as a model generation system, which includes a saved data storage unit which stores false data to be stored, a data generation unit which generates a first number of false data based on a generation model that is a neural network for generating false data, a discriminator unit which derives output values for given data based on a discriminator model that is a neural network for deriving output values indicating true data-likeness and false data-likeness of the given data, a gradient information calculation unit which calculates, for each combination of one true data and each of the first number of false data, a distance between the output value for the true data and the output value for the false data, and calculates gradient information that is an update amount for each weight that the discriminator model has, so as to increase the distance by a predetermined amount, and a selection unit which selects false data to be stored in the saved data storage unit from among the first number of false data based on the gradient information for each weight calculated for each false data, and stores the selected false data in the saved data storage unit.

A model generation program according to the present invention, that allows a computer to function as a model generation system, which includes a saved data storage unit which stores false data to be stored, a data generation unit which generates a first number of false data based on a generation model that is a neural network for generating false data, a discriminator unit which derives output values for given data based on a discriminator model that is a neural network for deriving output values indicating true data-likeness and false data-likeness of the given data, a distance calculation unit which calculates, for each combination of one true data and each of the first number of false data, a distance between the output value for the true data and the output value for the false data, and a selection unit which selects false data to be stored in the saved data storage unit from among the first number of false data based on the distance calculated for each false data, and stores the selected false data in the saved data storage unit.

### Advantageous Effects of Invention

According to the present invention, it is possible to generate each model in a generative adversarial network satisfactorily.

### BRIEF DESCRIPTION OF DRAWINGS

FIG. 1 It depicts a block diagram showing an example of a model generation system of an example embodiment of the present invention.

FIG. 2 It depicts a schematic diagram showing examples of a generation model and a discriminator model that are deep neural networks.

FIG. 3 It depicts a flowchart showing an example of the processing progress of an example embodiment of the present invention.

FIG. 4 It depicts a flowchart showing an example of the processing progress of an example embodiment of the present invention.

FIG. 5 It depicts a flowchart showing an example of the processing progress of an example embodiment of the present invention.

FIG. 6 It depicts a flowchart showing an example of the processing progress of an example embodiment of the present invention.

FIG. 7 It depicts a schematic block diagram showing a configuration example of a computer according to a model generation system of an example embodiment of the present invention.

FIG. 8 It depicts a block diagram showing an overview of the model generation system of the present invention.

FIG. 9 It depicts a block diagram showing another example of an overview of the model generation system of the present invention.

### DESCRIPTION OF EMBODIMENTS

Hereinafter, an example embodiment of the present invention is described with reference to the drawings.

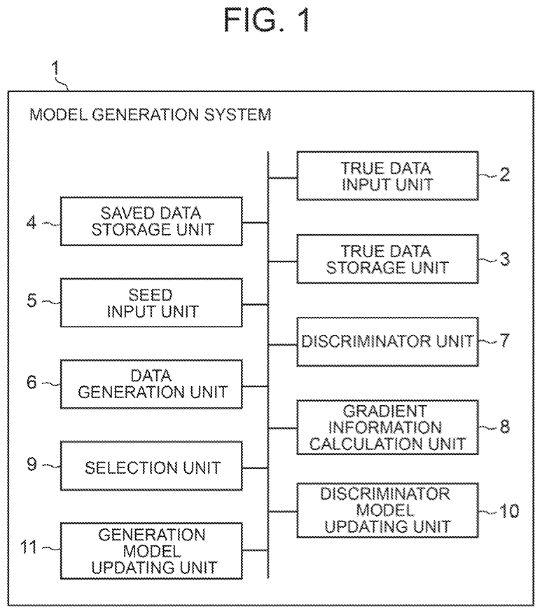

FIG. 1 is a block diagram showing an example of a model generation system of an example embodiment of the present invention. The model generation system 1 of this example embodiment includes a true data input unit 2, a true data storage unit 3, a saved data storage unit 4, a seed input unit 5, a data generation unit 6, a discriminator unit 7, a gradient information calculation unit 8, a selection unit 9, a discriminator model updating unit 10, a generation model updating unit 11.

In the following description, true data is data that has been defined as true data in advance.

The true data input unit 2 receives input of a plurality of true data from the outside and stores the plurality of true data in the true data storage unit 3.

The true data storage unit 3 is a storage device that stores the plurality of true data.

The plurality of true data input from the outside and stored in the true data storage unit 3 are fixed and are not replaced during the processing by the model generation system 1. However, if the model generation system 1 starts the process over from the beginning, the plurality of true data stored in the true data storage unit 3 may be replaced.

The saved data storage unit 4 is a storage device that stores false data to be stored. The false data to be stored is the false data selected by the selection unit 9 among the false data generated by the data generation unit 6. The saved data storage unit 4 stores a plurality of false data. No true data is stored in the saved data storage unit 4.

The true data and false data may be, for example, image data. In this case, the true data storage unit 3 stores the image data defined as true data. The data generation unit 6 also generates image data corresponding to the false data.

The true data and false data may be, for example, voice data. In this case, the true data storage unit 3 stores the voice data defined as true data. The data generation unit 6 also generates voice data corresponding to the false data.

The image data and the voice data are examples of true data and false data, and the true data and false data may be in other formats.

The data generation unit 6 uses a seed to generate false data based on a generation model. The generation model is a model for generating false data. The data generation unit 6 has a generation model.

The seed input unit 5 inputs the seed to the data generation unit 6. The seed is data that is input to the generation model when generating false data. The seed is represented, for example, by an array of random numbers.

The discriminator unit 7 is given data to be discriminated as true data or false data, and derives output values indicating the true data-likeness and false data-likeness of the given data. The discriminator unit 7 derives output values based on the discriminator model for deriving output values indicating true data-likeness and false data-likeness of the given data. The discriminator unit 7 may derive the output values by using the given data as input to the discriminator model. The discriminator unit 7 has a discriminator model.

Here, an example is taken in which the higher the true data-likeness of the given data (the more likely the given data is true data), the closer the output value is to 1, and the higher the false data-likeness of the given data (the more likely the given data is false data), the closer the output value is to 0. In this case, the range of possible output values is 0 to 1. However, another numerical range may be defined as the range of possible output values, instead of 0 to 1.

In addition to deriving output values for given data (data to be discriminated), the discriminator unit 7 also discriminates whether the given data is true data or false data. The discriminator unit 7 may discriminate whether the given data is true data or false data by using the given data as input to the discriminator model.

In this example embodiment, the case in which the generation model is a neural network for generating false data and the discriminator model is a neural network for deriving output values will be described as an example. More specifically, the case in which the generation model is a deep neural network for generating false data and the discriminator model is a deep neural network for deriving output values will be described as an example.

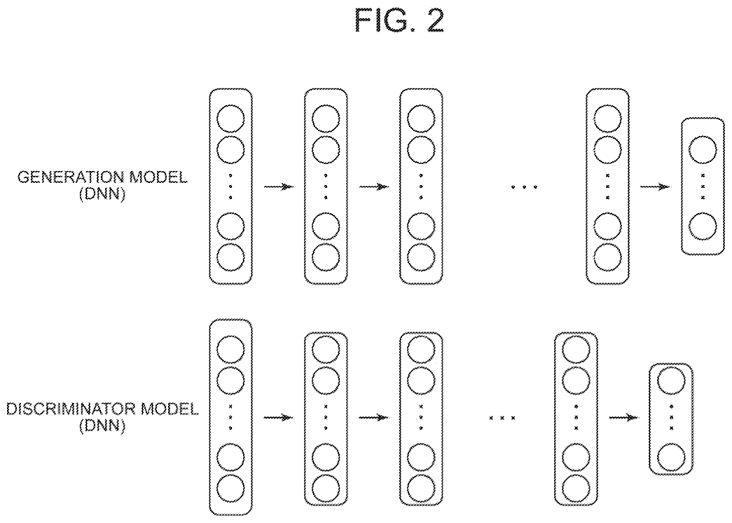

FIG. 2 is a schematic diagram showing examples of a generation model and a discriminator model that are deep neural networks. Hereafter, the deep neural network is referred to as DNN.

A DNN has a plurality of layers, each layer including one or more nodes (see FIG. 2). In FIG. 2, the layers are represented by rounded rectangles and the nodes are represented by circles.

Each individual node in the DNN has a defined weight. In other words, the DNN has a weight for each node.

The configuration of the layers and nodes in a DNN that serves as a generation model and the configuration of the layers and nodes in a DNN that serves as a discriminator model may be different. The configuration of layers and nodes means, for example, the number of layers and the number of nodes in a layer.

When generating false data, the data generation unit 6 generates a plurality of false data. This number of false data is noted as the first number, and the first number is denoted as y′ pieces. The first number is a plurality.

When the data generation unit 6 generates the first number (y′ pieces) of false data, the model generation system 1 performs an operation to update the discriminator model and the generation model, and an operation to select the false data to be stored in the saved data storage unit 4 from among the first number (y′ pieces) of false data in parallel.

The gradient information calculation unit 8 calculates the distance between the output value for true data and the output value for false data. The output value for true data is output value that the discriminator unit 7 derives by applying the true data to the discriminator model. The output value for false data is output value that the discriminator unit 7 derives by applying the false data to the discriminator model.

When the number of output values for true data and the number of output values for false data are one each, then the gradient information calculation unit 8 may use the absolute value of the difference between the two output values as the distance.

When the number of output values for true data and the number of output values for false data are each multiple, then the gradient information calculation unit 8 may use the absolute value of the difference between the average value of output values for true data and the average value of output values for false data as the distance.

The above methods of calculating the distance are examples, and the method of calculating the distance between the output value for true data and the output value for false data is not limited to the example above.

After calculating the distance, the gradient information calculation unit 8 calculates gradient information for each weight that the discriminator model has so that the distance is increased by a predetermined amount. The gradient information means an the update amount (change amount) for each weight in the case of updating the DNN by updating the weights of the DNN. The gradient information is calculated for each weight in the DNN (in other words, for each node).

The gradient information calculation unit 8 performs the operation of calculating the gradient information for each weight that the discriminator model has so as to increase the distance by a predetermined amount, in each of the operation for updating the discriminator model and the generation model and the operation for selecting the false data to be stored in the saved data storage unit 4 from among the y′ false data.

In the operation for updating the discriminator model and the generation model, after the gradient information is calculated for each weight that the discriminator model has, the discriminator model updating unit 10 updates the discriminator model by updating the individual weights of the discriminator model based on the gradient information according to the individual weights.

In the operation for selecting the false data to be stored in the saved data storage unit 4 from among the y′ false data, the gradient information calculation unit 8 performs an operation of calculating the distance between the output value for the true data and the output value for the false data for each combination of one true data and each of the y′ false data, and calculating the gradient information for each weight that the discriminator model has so that the distance is increased by a predetermined amount. As a result, for each y′ false data, the gradient information for each weight that the discriminator model has is obtained. Based on the gradient information for each weight that the discriminator model has calculated for each y′ false data, the selection unit 9 selects false data to be stored in the saved data storage unit 4 from among the y′ (first number) false data. Then, the selection unit 9 stores the selected false data in the saved data storage unit 4.

For example, the gradient information calculation unit 8 may calculate an average value of the absolute values of the gradient information for each weight that the discriminator model has for each y′ false data. Then, the selection unit 9 may select false data to be stored in the saved data storage unit 4 from among the y′ (first number) false data based on the average value calculated for each y′ false data.

In the process of operating to update the discriminator model and the generation model, the data generation unit 6 also generates a plurality of false data. This number of false data is noted as the second number, and the second number is denoted as z′ pieces. The second number is a plurality. In this case, the gradient information calculation unit 8 calculates the distance between the output value for true data and the output value for false data, and calculates the gradient information for each weight (in other words, for each node) that the generation model has so that the distance is decreased by a predetermined amount. Then, the generation model updating unit 11 updates the generation model by updating the individual weights of the generation model based on the gradient information according to the individual weights.

The true data input unit 2 is realized, for example, by a central processing unit (CPU) of a computer that operates according to a model generation program and an input device. For example, the CPU reads a model generation program from a program storage device or other program recording medium of the computer, and then, according to the model generation program, may operate as the true data input unit 2 by using the input device. The input device may be, for example, a data reading device that reads the plurality of true data recorded on a recording medium. The seed input unit 5, the data generation unit 6, the discriminator unit 7, the gradient information calculation unit 8, the selection unit 9, the discriminator model updating unit 10 and the generation model updating unit 11 are realized, for example, by the CPU operating according to the model generation program. For example, the CPU reads the model generation program from the program recording medium as described above, and according to the model generation program, may operate as the seed input unit 5, the data generation unit 6, the discriminator unit 7, the gradient information calculation unit 8, the selection unit 9, the discriminator model updating unit 10 and the generation model updating unit 11. The true data storage unit 3 and the saved data storage unit 4 are realized, for example, by a storage device provided by the computer.

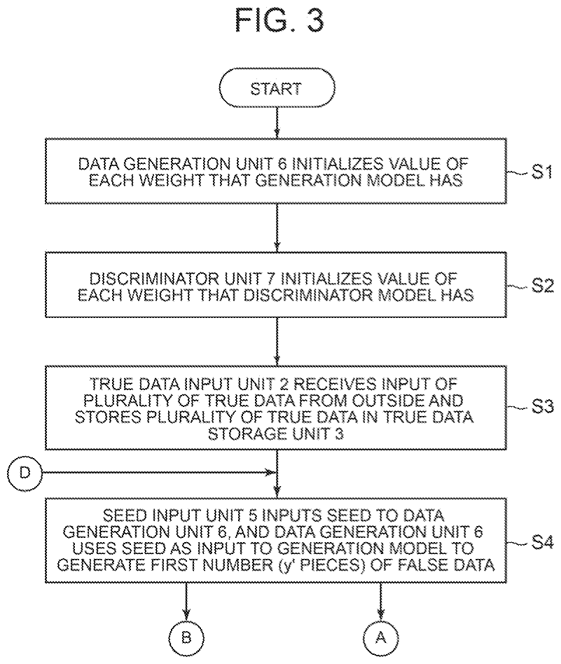

Next, the processing progress of the example embodiment of the present invention will be described. FIGS. 3 to 6 are flowcharts showing an example of the processing progress of the example embodiment of the present invention. It is assumed that the configuration of the generation model (DNN) that the data generation unit 6 has and the discriminator model (DNN) that the discriminator unit 7 has are predetermined. The configuration of the DNN means, for example, the number of layers, the number of nodes included in each layer, and the like.

It is also assumed that a certain number of false data has already been stored in the saved data storage unit 4. The operation when the number of false data stored in the saved data storage unit 4 does not reach the above certain number (i.e., when the number of false data stored in the saved data storage unit 4 is not sufficient) is described below.

First, the data generation unit 6 initializes the value of each weight that the generation model has (step S1). The data generation unit 6 may initialize the values of the weights, for example, by randomly determining the value of each weight of the generation model. Alternatively, the data generation unit 6 may initialize the value of each weight in other ways.

Next, the discriminator unit 7 initializes the value of each weight that the discriminator model has (step S2). The discriminator unit 7 may initialize the values of the weights, for example, by randomly determining the value of each weight of the discriminator model. Alternatively, the discriminator unit 7 may initialize the value of each weight in other ways.

Next, the true data input unit 2 receives input of a plurality of true data from the outside and stores the plurality of true data in the true data storage unit 3 (step S3). After step S3, the plurality of true data stored by the true data storage unit 3 are not replaced.

Next, the seed input unit 5 inputs a seed to the data generation unit 6, and the data generation unit 6 uses the seed as an input to the generation model to generate the first number (y′ pieces) of false data (step S4).

After step S4, the model generation system 1 performs the operation to update the discriminator model and the generation model, and the operation to select the false data to be stored in the saved data storage unit 4 from among the first number (y′ pieces) of false data in parallel.

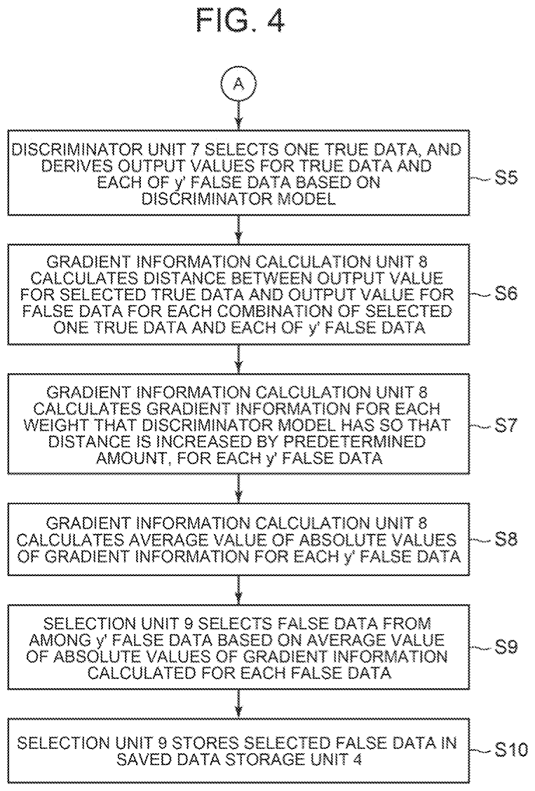

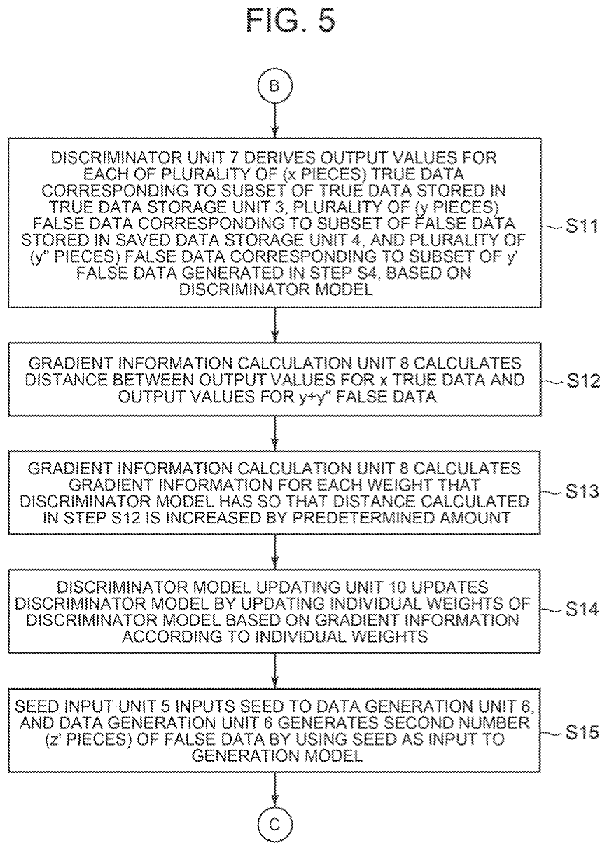

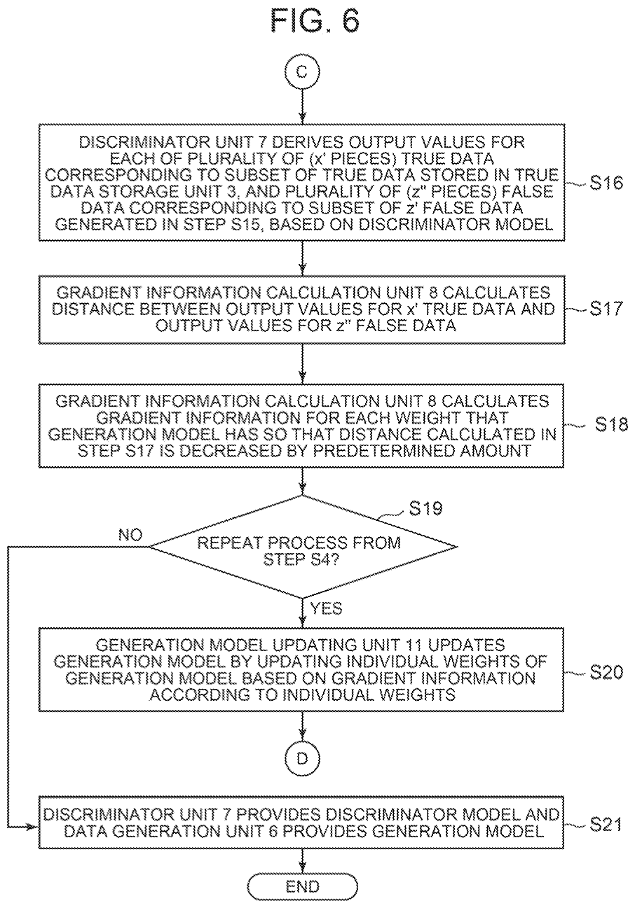

First, the operation to select the false data to be stored in the saved data storage unit 4 from among the first number (y′ pieces) of false data is described with reference to FIG. 4. The operation to update the discriminator model and the generation model are described below using FIGS. 5 and 6.

After step S4, the discriminator unit 7 selects one true data from among the plurality of true data stored in the true data input unit 2. At this time, the discriminator unit 7 may, for example, randomly select one true data. Then, the discriminator unit 7 derives output values for the one true data and each of the y′ false data generated in step S4 based on the discriminator model (step S5, see FIG. 4.).

Next, the gradient information calculation unit 8 calculates the distance between the output value for the selected true data and the output value for the false data for each combination of the selected one true data and each of the y′ false data (step S6). In step S6, the gradient information calculation unit 8 may calculate the absolute value of the difference between the output value for the true data and the output value for the false data for each combination of true data and false data as the distance. However, the method of calculating the distance in step S6 is not limited to this example.

As a result of step S6, a distance can be obtained for each y′ of false data.

Next to step S6, the gradient information calculation unit 8 calculates the gradient information for each weight that the discriminator model has so that the distance is increased by a predetermined amount, for each y′ false data (step S7).

The calculation of gradient information in step S7 uses a distance function with weights as variables. Equation (1) below is an example of a distance function.

[Math. 1]

E(w)=Σ_{ytrue} log[D(yₜᵣᵤₑ;w)]/NₜᵣᵤₑΣ_{yfake} log[1−D(y_{fake};w)]/N_{fake} (1)

In Equation (1), yₜᵣᵤₑ is true data and y_{fake} is false data. w is a weight. D(yₜᵣᵤₑ;w) is the output value for true data under the weight w. D(y_{fake};w) is the output value for false data under the weight w. Nₜᵣᵤₑ is the number of true data used to calculate the distance, and N_{fake} is the number of false data used to calculate the distance. When calculating the distance between the output value for one true data and the output value for one false data, Nₜᵣᵤₑ=1, N_{fake}=1.

When focusing on a certain weight wⁿ, the updated value of the weight is set to wⁿ⁺¹. In this case, the gradient information of the weight (denoted as ∇w) is expressed as in Equation (2) by using the distance function illustrated in Equation (1).

∇w=wⁿ⁺¹−wⁿ=−η∇E(wⁿ) (2)

Here, dE(w)/dw−η, and η is a fixed value. η is called the learning rate.

In step S7, the gradient information calculation unit 8 may calculate the gradient information for each weight that the discriminator model has by using Equation (2).

Such calculation of the gradient information can be said to be calculation by the backpropagation.

When calculating the gradient information for each weight of the discriminator model in step S13 below, and when calculating the gradient information for each weight of the generation model in step S18, the gradient information calculation unit 8 may calculate the gradient information by the backpropagation as described above.

As a result of step S7, the gradient information of each weight of the discriminator model is obtained for each false data. Next to step S7, the gradient information calculation unit 8 calculates an average value of the absolute values of the gradient information for each weight for each y′ false data (step S8). The average value of the absolute values of the gradient information can be obtained by calculating Equation (3).

Σ|∇w|/N (3)

In Equation (3), N is the number of weights that the discriminator model has.

Next, the selection unit 9 selects false data from among the y′ false data based on the average value of the absolute values of the gradient information calculated for each y′ false data (step S9). The number of false data selected in step S9 may be multiple.

Here, a case where, in step S8, the gradient information calculation unit 8 calculates the average value of the absolute values of the gradient information for each false data, and in step S9, the selection unit 9 selects false data based on the average value of the absolute values of the gradient information has been described as an example. The average value of the absolute values of the gradient information is an example of an index of the magnitude of the absolute value of the gradient information. In step S8, the gradient information calculation unit 8 may calculate such an index for each false data, and in step S9, the selection unit 9 may select false data based on such index. Another example of an index of the magnitude of the absolute value of the gradient information is, for example, a sum of the absolute values of the gradient information.

In step S9, it is sufficient to select the false data with a large index of the magnitude of the absolute value of the gradient information. In this example embodiment, for example, the selection unit 9 may select a number of false data equivalent to 10% of y′ from among the y′ false data in descending order of the average value of the absolute values of the gradient information. For example, the selection unit 9 may select a number of false data equivalent to 1/9 of the number of false data stored in the saved data storage unit 4 from among the y′ false data in descending order of the average value of the absolute values of the gradient information. However, the above “10%” and “ 1/9” are examples, and are not limited to these percentages.

Next, the selection unit 9 stores the false data selected in step S9 in the saved data storage unit 4 (step S10).

The model generation system 1 executes steps S5 to S10 (see FIG. 4) each time step S4 (see FIG. 3) is executed.

The operation for updating the discriminator model and the generation model will be described with reference to FIGS. 5 and 6.

After step S4 (see FIG. 3), the discriminator unit 7 derives output values for each of the plurality of (x pieces) true data corresponding to a subset of true data stored in the true data storage unit 3, the plurality of (y pieces) false data corresponding to a subset of false data stored in the saved data storage unit 4, and the plurality of (y″ pieces) false data corresponding to a subset of y′ false data generated in step S4, based on the discriminator model (step S11).

It is preferable that x and y+y″ are close values, but it is not always necessary that x=y+y″.

Next, the gradient information calculation unit 8 calculates the distance between the output values for x true data and the output values for y+y″ false data (step S12).

For example, the gradient information calculation unit 8 may calculate the absolute value of the difference between an average value of output values for x true data and an average value of output values for y+y″ false data as the distance. However, the method of calculating the distance in step S12 is not limited to the above example.

Next, the gradient information calculation unit 8 calculates the gradient information for each weight that the discriminator model has so that the distance calculated in step S12 is increased by a predetermined amount (step S13). For example, the gradient information calculation unit 8 may calculate the gradient information by using the backpropagation.

Next, the discriminator model updating unit 10 updates the discriminator model by updating the individual weights of the discriminator model based on the gradient information according to the individual weights (step S14). Since the gradient information is the update amount (change amount) of the weight, the discriminator model updating unit 10 may add to the weight the gradient information corresponding to the weight.

Next, the seed input unit 5 inputs the seed to the data generation unit 6, and the data generation unit 6 generates a second number (z′ pieces) of false data by using the seed as an input to the generation model (step S15).

Next, the discriminator unit 7 derives output values for each of the plurality of (x′ pieces) true data corresponding to a subset of true data stored in the true data storage unit 3, and the plurality of (z″ pieces) false data corresponding to a subset of z′ false data generated in step S15, based on the discriminator model (step S16, see FIG. 6).

It is preferable that x′ and z″ are close values, but it is not always necessary that x′=z″.

Next, the gradient information calculation unit 8 calculates the distance between the output values for x′ true data and the output values for z″ false data (step S17).

For example, the gradient information calculation unit 8 may calculate the absolute value of the difference between an average value of output values for x″ true data and an average value of output values for z″ false data as the distance. However, the method of calculating the distance in step S17 is not limited to the above example.

Next, the gradient information calculation unit 8 calculates the gradient information for each weight that the generation model has so that the distance calculated in step S17 is decreased by a predetermined amount (step S18). For example, the gradient information calculation unit 8 may calculate the gradient information by using the backpropagation.

The operation from step S4 to step S20 described below is a repetitive process. After step S18, for example, the data generation unit 6 determines whether to repeat this process from step S4 (step S19).

For example, when the number of repetitions of the processes of steps S4 and S11 to S20 (see FIGS. 3, 5, and 6) has not reached a predetermined threshold value, the process from step S4 may be determined to be repeated, and when the number of repetitions has reached the predetermined threshold value, the process from step S4 may be determined not to be repeated. However, the criteria for the determination in step S19 are not limited to the above example. For example, when the distance calculated in step S12 is greater than or equal to a threshold value, then it may be determined that the process from step S4 is repeated, and when the distance is less than the threshold value, then the process from step S4 may be determined not to be repeated.

In this example, the case in which the data generation unit 6 performs the determination in step S19 is described as an example, but the determination in step S19 may be performed by an element other than the data generation unit 6.

When it is determined that the process from step S4 is repeated (Yes in step S19), the generation model updating unit 11 updates the generation model by updating the individual weights of the generation model based on the gradient information according to the individual weights (step S20). Since the gradient information is the update amount (change amount) of the weight, the generation model updating unit 11 may add to the weight the gradient information corresponding to the weight.

After step S20, the process moves to step S4 (see FIG. 3). When the seed input unit 5 and the data generation unit 6 execute step S4 again, the model generation system 1 performs the operation (operations from step S11 onwards) to update the discriminator model and the generation model, and the operation (operations of steps S5 to S10) to select the false data to be stored in the saved data storage unit 4 from among the first number (y′ pieces) of false data is performed in parallel.

When it is determined that the process from step S4 is not repeated (No in step S19), the discriminator unit 7 provides the discriminator model and the data generation unit 6 provides the generation model (step S21). For example, the discriminator unit 7 stores the discriminator model in an external storage device (not shown) and the data generation unit 6 also stores the generation model in an external storage device. As a result, the discriminator model and the generation model are available outside the model generation system 1.

In the above description, the case where a certain number or more of false data is already stored in the stored data storage unit 4 has been described. Next, the case where the number of false data stored in the saved data storage unit 4 has not reached the above the certain number (i.e., the number of false data stored in the saved data storage unit 4 is not sufficient) is described. Detailed descriptions of the operations already described are omitted. In this case, the model generation system 1 executes steps S1 to S4. Then, at the end of step S4, it is assumed that the number of false data stored in the saved data storage unit 4 has not reached the certain number. In this case, the model generation system 1 repeats the operations of steps S4 to S10 until the number of false data stored in the saved data storage unit 4 reaches the certain number. However, at this time, even if the model generation system 1 executes step S4, the processing after step S11 is not executed. By repeating the operation of steps S4 to S10, each time step S10 is performed, false data is added to the saved data storage unit 4, so that the number of false data stored in the saved data storage unit 4 will increase and reach the certain number.

After the number of false data stored in the saved data storage unit 4 reaches the certain number, the model generation system 1 performs the operation after step S11 and the operation of steps S5 to S10 in parallel, after the execution of step S4.

Further, an upper limit value of the number of false data that can be stored in the saved data storage unit 4 may be defined. When the number of false data stored in the saved data storage unit 4 has reached the upper limit value, in the case where the selection unit 9 stores the selected false data in the saved data storage unit 4 (step S10), the selection unit 9 may delete the same number of false data as the selected false data from the saved data storage unit 4. Even if the selection unit 9 stores the selected false data in the saved data storage unit 4 after the number of false data stored in the saved data storage unit 4 reaches the upper limit value, by such operation, the number of false data in the saved data storage unit 4 will be kept at an upper limit value. The selection unit 9 may randomly determine the false data to be deleted from the saved data storage unit 4. Alternatively, the selection unit 9 may determine the false data to be deleted from the saved data storage unit 4 by another method.

According to this example embodiment, not all of the y′ false data generated in step S4 are stored in the saved data storage unit 4, for example, the gradient information calculation unit 8 calculates the average value of the absolute values of the gradient information for each false data, and the selection unit 9 selects the false data from among the y′ false data based on the average value of the absolute values of the gradient information calculated for each false data, and stores the selected false data in the saved data storage unit 4. Then, the false data stored in the saved data storage unit 4 is used when updating the discriminator model. Thus, it is prevented from storing undesirable false data in the saved data storage unit 4, such that the discrimination accuracy of the discriminator model is increased only for false data that is extremely easy or difficult to discriminate, and it prevents such undesirable false data from being used to update the discriminator model.

As a result, according to this example embodiment, it is possible to generate the discriminator model and the generation model satisfactorily (in other words, stably). It can also be said that the data generation unit 6 and the discriminator unit 7 correspond to the generator and the discriminator in the generative adversarial networks. Therefore, according to this example embodiment, it is possible to generate the discriminator model and the generation model in the generative adversarial networks satisfactorily (in other words, stably).

Furthermore, according to this example embodiment, the processes of steps S4 and S11 to S20 (see FIGS. 3, 5, and 6) are repeatedly executed. This repetitive processing also includes the process of updating the discriminator model (steps S11 to S14), in the process of updating the discriminator model, not only the false data newly generated in step S4 but also the false data stored in the saved data storage unit 4 are used as false data. Specifically, in the process of updating the discriminator model (steps S11 to S14), the plurality of (y pieces) false data corresponding to a subset of false data stored in the saved data storage unit 4, and the plurality of (y″ pieces) false data corresponding to a subset of y′ false data generated in step S4 (see step S11 shown in FIG. 5).

In other words, the process of updating the discriminator model (steps S11 to S14) is also executed repeatedly, but at this time, the false data (the false data stored in the saved data storage unit 4) used in the past steps S11 to S14 is also used again. Therefore, for example, the discrimination accuracy of the discriminator model is prevented from being specifically high for the false data generated in the most recent step S4 by the data generation unit 6.

Therefore, according to this example embodiment, the effect that the discriminator model and the generation model can be generated satisfactorily (in other words, stably) can be further enhanced.

Next, a modification example of the example embodiment of the present invention is described.

In the above example embodiment, when selecting false data from among y′ (first number) false data, the case where the gradient information calculation unit 8 calculates, for each false data, an index of the magnitude of the absolute value of the gradient information (for example, the average value of the absolute values of the gradient information), and the selection unit 9 selects false data from among y′ data based on the index calculated for each false data has been described.

In step S6, the distance (the distance between the output value for the selected true data and the output value for the false data) calculated for each combination (in other words, for each y′ false data) of one selected true data and each of y′ false data may be treated as an index of the magnitude of the absolute value of the gradient information. That is, instead of an index of the magnitude of the absolute value of the gradient information (for example, the average value of the absolute values of the gradient information), the distance (the distance between the output value for the selected true data and the output value for the false data) calculated for each false data may be used. For example, the selection unit 9 may select the false data with the larger distance calculated for each false data. For example, the selection unit 9 may select a number of false data equivalent to 10% of y′ from among the y′ false data in descending order of the distance. However, the above 10% is an example, and is not limited to this percentage.

In this modification example, the gradient information calculation unit 8 when executing step S6 can be referred to as a distance calculation unit. Then, after step S6, the process moves to step S9, and in step S9, the selection unit 9 may select the false data based on the distance calculated for each false data.

Other aspects are the same as those described above.

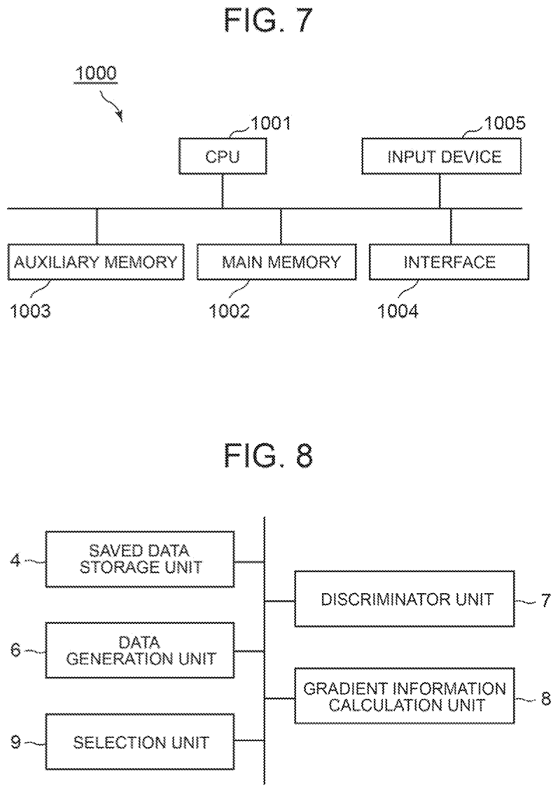

FIG. 7 is a schematic block diagram showing a configuration example of a computer according to the model generation system 1 of the example embodiment of the present invention. The computer 1000 includes a CPU 1001, a main memory 1002, an auxiliary memory 1003, an interface 1004, and an input device 1005.

The model generation system 1 of the example embodiment of the present invention is realized by the computer 1000. The operation of the model generation system 1 is stored in a form of a program (model generation program) in the auxiliary memory 1003. The CPU 1001 reads the program from the auxiliary memory 1003, expands it to the main memory 1002, and executes the process described in the above example embodiment according to the program. In this case, the true data input unit 2 is realized by the CPU 1001 and the input device 1005. The seed input unit 5, the data generation unit 6, the discriminator unit 7, the gradient information calculation unit 8, the selection unit 9, the discriminator model updating unit 10 and the generation model updating unit 11 are realized by the CPU 1001. The true data storage unit 3 and the saved data storage unit 4 may be realized by, for example, the auxiliary memory 1003, or may be realized by another storage device.

The auxiliary memory 1003 is an example of a non-transitory tangible medium. Other examples of non-transitory tangible media include a magnetic disk, an optical magnetic disk, a CD-ROM (Compact Disc Read only memory), a DVD-ROM (Digital Versatile Disk Read only memory), a semiconductor memory, and the like. When the program is transmitted to the computer 1000 through a communication line, the computer 1000 receiving the transmission may expand the program to the main memory 1002 and perform the processes described in the above example embodiments according to the program.

Some or all of the components may be realized by a general-purpose or a dedicated circuit (circuitry), a processor, or a combination of these. They may be configured by a single chip or by multiple chips connected via a bus. Some or all of the components may be realized by a combination of the above-mentioned circuitry, etc. and a program.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

Next, an overview of the present invention will be described. FIG. 8 is a block diagram showing an overview of the model generation system of the present invention. The model generation system of the present invention includes the saved data storage unit 4, the data generation unit 6, the discriminator unit 7, the gradient information calculation unit 8, and the selection unit 9.

The saved data storage unit 4 stores false data to be stored.

The data generation unit 6 generates a first number (for example, y′ pieces) of false data based on a generation model that is a neural network for generating false data.

The discriminator unit 7 derives output values for given data based on a discriminator model that is a neural network for deriving output values indicating true data-likeness and false data-likeness of the given data.

The gradient information calculation unit 8 calculates, for each combination of one true data and each of the first number of false data, the distance between the output value for the true data and the output value for the false data, and calculates gradient information that is an update amount for each weight that the discriminator model has, so as to increase the distance by a predetermined amount.

The selection unit 9 selects false data to be stored in the saved data storage unit 4 from among the first number of false data based on the gradient information for each weight calculated for each false data, and stores the selected false data in the saved data storage unit 4.

With such a configuration, it is possible to generate the discriminator model and the generation model in the generative adversarial networks satisfactorily.

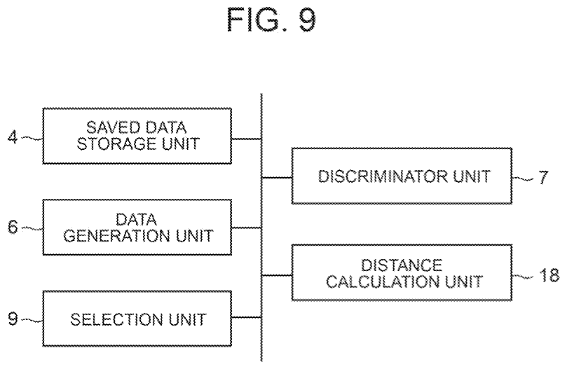

FIG. 9 is a block diagram showing another example of an overview of the model generation system of the present invention. The model generation system of the present invention may include the saved data storage unit 4, the data generation unit 6, the discriminator unit 7, a distance calculation unit 18, the selection unit 9.

The saved data storage unit 4, the data generation unit 6 and the discriminator unit 7 shown in FIG. 9 are the same as the saved data storage unit 4, the data generation unit 6 and the discriminator unit 7 shown in FIG. 8, and the description is omitted.

The distance calculation unit 18 (for example, gradient information calculation unit 8 when executing step S6 in the modification example of the above-described example embodiment) calculates, for each combination of one true data and each of the first number of false data, the distance between the output value for the true data and the output value for the false data.

The selection unit 9 selects false data to be stored in the saved data storage unit 4 from among the first number of false data based on the distance calculated for each false data, and stores the selected false data in the saved data storage unit 4.

Even with such a configuration, it is possible to generate the discriminator model and the generation model in the generative adversarial networks satisfactorily.

The above example embodiment of the present invention can be described as supplementary notes mentioned below, but are not limited to the following supplementary notes.

(Supplementary note 1) A model generation system, comprising:
a saved data storage unit which stores false data to be stored,
a data generation unit which generates a first number of false data based on a generation model that is a neural network for generating false data,
a discriminator unit which derives output values for given data based on a discriminator model that is a neural network for deriving output values indicating true data-likeness and false data-likeness of the given data,
a gradient information calculation unit which calculates, for each combination of one true data and each of the first number of false data, a distance between the output value for the true data and the output value for the false data, and calculates gradient information that is an update amount for each weight that the discriminator model has, so as to increase the distance by a predetermined amount, and
a selection unit which selects false data to be stored in the saved data storage unit from among the first number of false data based on the gradient information for each weight calculated for each false data, and stores the selected false data in the saved data storage unit.

(Supplementary note 2) The model generation system according to Supplementary note 1, further comprising,
a discriminator model updating unit which updates the discriminator model, and
a generation model updating unit which updates the generation model,
wherein the discriminator unit derives output values for each of the plurality of true data corresponding to a subset of the plurality of true data prepared in advance, the plurality of false data corresponding to a subset of false data stored in the saved data storage unit, and the plurality of false data corresponding to a subset of the first number of false data,
the gradient information calculation unit calculates the distance between the output value for true data and the output value for false data derived by the discriminator unit, and calculates gradient information for each weight of the discriminator model, so as to increase the distance by a predetermined amount,
the discriminator model updating unit updates the discriminator model by updating the individual weights of the discriminator model based on the gradient information according to the individual weights,
the data generation unit generates a second number of false data,
the discriminator unit derives output values for each of the plurality of true data corresponding to a subset of the plurality of true data prepared in advance and the plurality of false data corresponding to a subset of the second number of false data,
the gradient information calculation unit calculates the distance between the output value for true data and the output value for false data derived by the discriminator unit, and calculates gradient information for each weight of the generation model, so as to decrease the distance by a predetermined amount, and
the generation model updating unit updates the generation model by updating the individual weights of the generation model based on the gradient information according to the individual weights.

(Supplementary note 3) The model generation system according to Supplementary note 1 or 2,
wherein the gradient information calculation unit, for each combination of one true data and each of the first number of false data, calculates the distance between the output value for the true data and the output value for the false data, calculates gradient information for each weight of the discriminator model so as to increase the distance by a predetermined amount, and calculates an average value of the absolute values of the gradient information for each weight, and
the selection unit selects false data to be stored in the saved data storage unit from the first number of false data based on the average value calculated for each false data.

(Supplementary note 4) A model generation system, comprising:
a saved data storage unit which stores false data to be stored,
a data generation unit which generates a first number of false data based on a generation model that is a neural network for generating false data,
a discriminator unit which derives output values for given data based on a discriminator model that is a neural network for deriving output values indicating true data-likeness and false data-likeness of the given data,
a distance calculation unit which calculates, for each combination of one true data and each of the first number of false data, a distance between the output value for the true data and the output value for the false data, and
a selection unit which selects false data to be stored in the saved data storage unit from among the first number of false data based on the distance calculated for each false data, and stores the selected false data in the saved data storage unit.

(Supplementary note 5) The model generation system according to Supplementary note 4, further comprising,
a discriminator model updating unit which updates the discriminator model, and
a generation model updating unit which updates the generation model,
wherein the discriminator unit derives output values for each of the plurality of true data corresponding to a subset of the plurality of true data prepared in advance, the plurality of false data corresponding to a subset of false data stored in the saved data storage unit, and the plurality of false data corresponding to a subset of the first number of false data,
wherein the model generation system comprises:
a gradient information calculation unit which calculates the distance between the output value for true data and the output value for false data derived by the discriminator unit, and calculates gradient information for each weight of the discriminator model, so as to increase the distance by a predetermined amount,
wherein the discriminator model updating unit updates the discriminator model by updating the individual weights of the discriminator model based on the gradient information according to the individual weights,
the data generation unit generates a second number of false data,
the discriminator unit derives output values for each of the plurality of true data corresponding to a subset of the plurality of true data prepared in advance and the plurality of false data corresponding to a subset of the second number of false data,
the gradient information calculation unit calculates the distance between the output value for true data and the output value for false data derived by the discriminator unit, and calculates gradient information for each weight of the generation model, so as to decrease the distance by a predetermined amount, and
the generation model updating unit updates the generation model by updating the individual weights of the generation model based on the gradient information according to the individual weights.

(Supplementary note 6) The model generation system according to any one of Supplementary notes 1 to 5,
wherein the selection unit deletes, if the number of false data stored in the saved data storage unit has reached a predetermined number, when the selected false data is stored in the saved data storage unit, the same number of false data as the selected false data from the saved data storage unit.

(Supplementary note 7) The model generation system according to any one of Supplementary notes 1 to 6,
wherein the discriminator model and the generation model are deep neural networks.

(Supplementary note 8) The model generation system according to any one of Supplementary notes 1 to 7,
wherein the true data and the false data are image data or voice data.

(Supplementary note 9) A model generation method implemented by a computer, comprising:
generating a first number of false data based on a generation model that is a neural network for generating false data,
deriving output values for given data based on a discriminator model that is a neural network for deriving output values indicating true data-likeness and false data-likeness of the given data,
calculating, for each combination of one true data and each of the first number of false data, a distance between the output value for the true data and the output value for the false data, and calculating gradient information that is an update amount for each weight that the discriminator model has, so as to increase the distance by a predetermined amount, and
selecting false data to be stored in the saved data storage unit, which stores false data to be stored, from among the first number of false data based on the gradient information for each weight calculated for each false data, and storing the selected false data in the saved data storage unit.

(Supplementary note 10) A model generation method implemented by a computer, comprising:
generating a first number of false data based on a generation model that is a neural network for generating false data,
deriving output values for given data based on a discriminator model that is a neural network for deriving output values indicating true data-likeness and false data-likeness of the given data,
calculating, for each combination of one true data and each of the first number of false data, a distance between the output value for the true data and the output value for the false data, and
selecting false data to be stored in the saved data storage unit, which stores false data to be stored, from among the first number of false data based on the distance calculated for each false data, and storing the selected false data in the saved data storage unit.

(Supplementary note 11) The model generation method according to Supplementary note 9 or 10, implemented by a computer, further comprising,
deriving output values for each of the plurality of true data corresponding to a subset of the plurality of true data prepared in advance, the plurality of false data corresponding to a subset of false data stored in the saved data storage unit, and the plurality of false data corresponding to a subset of the first number of false data, calculating the distance between the output value for true data and the output value for false data, and calculating gradient information for each weight of the discriminator model, so as to increase the distance by a predetermined amount,
updating the discriminator model by updating the individual weights of the discriminator model based on the gradient information according to the individual weights,
generating a second number of false data,
deriving output values for each of the plurality of true data corresponding to a subset of the plurality of true data prepared in advance and the plurality of false data corresponding to a subset of the second number of false data, calculating the distance between the output value for true data and the output value for false data, and calculating gradient information for each weight of the generation model, so as to decrease the distance by a predetermined amount, and
updating the generation model by updating the individual weights of the generation model based on the gradient information according to the individual weights.

(Supplementary note 12) A model generation program that allows a computer to function as a model generation system, which comprises:
a saved data storage unit which stores false data to be stored,
a data generation unit which generates a first number of false data based on a generation model that is a neural network for generating false data,
a discriminator unit which derives output values for given data based on a discriminator model that is a neural network for deriving output values indicating true data-likeness and false data-likeness of the given data,
a gradient information calculation unit which calculates, for each combination of one true data and each of the first number of false data, a distance between the output value for the true data and the output value for the false data, and calculates gradient information that is an update amount for each weight that the discriminator model has, so as to increase the distance by a predetermined amount, and
a selection unit which selects false data to be stored in the saved data storage unit from among the first number of false data based on the gradient information for each weight calculated for each false data, and stores the selected false data in the saved data storage unit.

(Supplementary note 13) A model generation program according to Supplementary note 12 that allows the computer to function as the model generation system, which comprises:
a discriminator model updating unit which updates the discriminator model, and
a generation model updating unit which updates the generation model,
wherein the discriminator unit derives output values for each of the plurality of true data corresponding to a subset of the plurality of true data prepared in advance, the plurality of false data corresponding to a subset of false data stored in the saved data storage unit, and the plurality of false data corresponding to a subset of the first number of false data,
the gradient information calculation unit calculates the distance between the output value for true data and the output value for false data derived by the discriminator unit, and calculates gradient information for each weight of the discriminator model, so as to increase the distance by a predetermined amount,
the discriminator model updating unit updates the discriminator model by updating the individual weights of the discriminator model based on the gradient information according to the individual weights,
the data generation unit generates a second number of false data,
the discriminator unit derives output values for each of the plurality of true data corresponding to a subset of the plurality of true data prepared in advance and the plurality of false data corresponding to a subset of the second number of false data,
the gradient information calculation unit calculates the distance between the output value for true data and the output value for false data derived by the discriminator unit, and calculates gradient information for each weight of the generation model, so as to decrease the distance by a predetermined amount, and
the generation model updating unit updates the generation model by updating the individual weights of the generation model based on the gradient information according to the individual weights.

(Supplementary note 14) A model generation program that allows a computer to function as a model generation system, which comprises:
a saved data storage unit which stores false data to be stored,
a data generation unit which generates a first number of false data based on a generation model that is a neural network for generating false data,
a discriminator unit which derives output values for given data based on a discriminator model that is a neural network for deriving output values indicating true data-likeness and false data-likeness of the given data,
a distance calculation unit which calculates, for each combination of one true data and each of the first number of false data, a distance between the output value for the true data and the output value for the false data, and
a selection unit which selects false data to be stored in the saved data storage unit from among the first number of false data based on the distance calculated for each false data, and stores the selected false data in the saved data storage unit.

(Supplementary note 15) A model generation program according to Supplementary note 14 that allows the computer to function as the model generation system, which comprises:
a discriminator model updating unit which updates the discriminator model, and
a generation model updating unit which updates the generation model,
wherein the discriminator unit derives output values for each of the plurality of true data corresponding to a subset of the plurality of true data prepared in advance, the plurality of false data corresponding to a subset of false data stored in the saved data storage unit, and the plurality of false data corresponding to a subset of the first number of false data,
wherein the model generation system comprises:
a gradient information calculation unit which calculates the distance between the output value for true data and the output value for false data derived by the discriminator unit, and calculates gradient information for each weight of the discriminator model, so as to increase the distance by a predetermined amount,
wherein the discriminator model updating unit updates the discriminator model by updating the individual weights of the discriminator model based on the gradient information according to the individual weights,
the data generation unit generates a second number of false data,
the discriminator unit derives output values for each of the plurality of true data corresponding to a subset of the plurality of true data prepared in advance and the plurality of false data corresponding to a subset of the second number of false data,
the gradient information calculation unit calculates the distance between the output value for true data and the output value for false data derived by the discriminator unit, and calculates gradient information for each weight of the generation model, so as to decrease the distance by a predetermined amount, and
the generation model updating unit updates the generation model by updating the individual weights of the generation model based on the gradient information according to the individual weights.

Although the present invention has been described above with reference to the example embodiments, the present invention is not limited to the above example embodiments. Various changes understandable to those skilled in the art within the scope of the present invention can be made to the structures and details of the present invention.

### INDUSTRIAL APPLICABILITY

The present invention is suitably applied to a model generation system that generates a model in generative adversarial networks.

### REFERENCE SIGNS LIST

1 Model generation system
2 True data input unit
3 True data storage unit
4 Saved data storage unit
5 Seed input unit
6 Data generation unit
7 Discriminator unit
8 Gradient information calculation unit
9 Selection unit
10 Discriminator model updating unit
11 Generation model updating unit

What is claimed is:

1. A model generation system, comprising:
a saved data storage unit which stores false data to be stored,
a data generation unit which generates a first number of false data based on a generation model that is a neural network for generating false data,
a discriminator unit which derives output values for given data based on a discriminator model that is a neural network for deriving output values indicating true data-likeness and false data-likeness of the given data,
a gradient information calculation unit which calculates, for each combination of one true data and each of the first number of false data, a distance between the output value for the true data and the output value for the false data, and calculates gradient information that is an update amount for each weight that the discriminator model has, so as to increase the distance by a predetermined amount, and
a selection unit which selects false data to be stored in the saved data storage unit from among the first number of false data based on the gradient information for each weight calculated for each false data, and stores the selected false data in the saved data storage unit.

2. The model generation system according to claim 1, further comprising,
a discriminator model updating unit which updates the discriminator model, and
a generation model updating unit which updates the generation model,
wherein the discriminator unit derives output values for each of the plurality of true data corresponding to a subset of the plurality of true data prepared in advance, the plurality of false data corresponding to a subset of false data stored in the saved data storage unit, and the plurality of false data corresponding to a subset of the first number of false data,
the gradient information calculation unit calculates the distance between the output value for true data and the output value for false data derived by the discriminator unit, and calculates gradient information for each weight of the discriminator model, so as to increase the distance by a predetermined amount,
the discriminator model updating unit updates the discriminator model by updating the individual weights of the discriminator model based on the gradient information according to the individual weights,
the data generation unit generates a second number of false data,
the discriminator unit derives output values for each of the plurality of true data corresponding to a subset of the plurality of true data prepared in advance and the plurality of false data corresponding to a subset of the second number of false data,
the gradient information calculation unit calculates the distance between the output value for true data and the output value for false data derived by the discriminator unit, and calculates gradient information for each weight of the generation model, so as to decrease the distance by a predetermined amount, and
the generation model updating unit updates the generation model by updating the individual weights of the generation model based on the gradient information according to the individual weights.

3. The model generation system according to claim 1,
wherein the gradient information calculation unit, for each combination of one true data and each of the first number of false data, calculates the distance between the output value for the true data and the output value for the false data, calculates gradient information for each weight of the discriminator model so as to increase the distance by a predetermined amount, and calculates an average value of the absolute values of the gradient information for each weight, and
the selection unit selects false data to be stored in the saved data storage unit from the first number of false data based on the average value calculated for each false data.

4. A model generation system, comprising:
a saved data storage unit which stores false data to be stored,
a data generation unit which generates a first number of false data based on a generation model that is a neural network for generating false data,
a discriminator unit which derives output values for given data based on a discriminator model that is a neural network for deriving output values indicating true data-likeness and false data-likeness of the given data,
a distance calculation unit which calculates, for each combination of one true data and each of the first number of false data, a distance between the output value for the true data and the output value for the false data, and
a selection unit which selects false data to be stored in the saved data storage unit from among the first number of false data based on the distance calculated for each false data, and stores the selected false data in the saved data storage unit.

5. The model generation system according to claim 4, further comprising,
a discriminator model updating unit which updates the discriminator model, and
a generation model updating unit which updates the generation model,
wherein the discriminator unit derives output values for each of the plurality of true data corresponding to a subset of the plurality of true data prepared in advance, the plurality of false data corresponding to a subset of false data stored in the saved data storage unit, and the plurality of false data corresponding to a subset of the first number of false data,
wherein the model generation system comprises:
a gradient information calculation unit which calculates the distance between the output value for true data and the output value for false data derived by the discriminator unit, and calculates gradient information for each weight of the discriminator model, so as to increase the distance by a predetermined amount,
wherein the discriminator model updating unit updates the discriminator model by updating the individual weights of the discriminator model based on the gradient information according to the individual weights,
the data generation unit generates a second number of false data,
the discriminator unit derives output values for each of the plurality of true data corresponding to a subset of the plurality of true data prepared in advance and the plurality of false data corresponding to a subset of the second number of false data,
the gradient information calculation unit calculates the distance between the output value for true data and the output value for false data derived by the discriminator unit, and calculates gradient information for each weight of the generation model, so as to decrease the distance by a predetermined amount, and
the generation model updating unit updates the generation model by updating the individual weights of the generation model based on the gradient information according to the individual weights.

6. The model generation system according to claim 1,
wherein the selection unit deletes, if the number of false data stored in the saved data storage unit has reached a predetermined number, when the selected false data is stored in the saved data storage unit, the same number of false data as the selected false data from the saved data storage unit.

7. The model generation system according to claim 1,
wherein the discriminator model and the generation model are deep neural networks.

8. The model generation system according to claim 1,
wherein the true data and the false data are image data or voice data.

9. A model generation method implemented by a computer, comprising:
generating a first number of false data based on a generation model that is a neural network for generating false data,
deriving output values for given data based on a discriminator model that is a neural network for deriving output values indicating true data-likeness and false data-likeness of the given data,
calculating, for each combination of one true data and each of the first number of false data, a distance between the output value for the true data and the output value for the false data, and calculating gradient information that is an update amount for each weight that the discriminator model has, so as to increase the distance by a predetermined amount, and
selecting false data to be stored in the saved data storage unit, which stores false data to be stored, from among the first number of false data based on the gradient information for each weight calculated for each false data, and storing the selected false data in the saved data storage unit.

10. (canceled)

11. The model generation method according to claim 9, implemented by a computer, further comprising,
deriving output values for each of the plurality of true data corresponding to a subset of the plurality of true data prepared in advance, the plurality of false data corresponding to a subset of false data stored in the saved data storage unit, and the plurality of false data corresponding to a subset of the first number of false data, calculating the distance between the output value for true data and the output value for false data, and calculating gradient information for each weight of the discriminator model, so as to increase the distance by a predetermined amount,
updating the discriminator model by updating the individual weights of the discriminator model based on the gradient information according to the individual weights,
generating a second number of false data,
deriving output values for each of the plurality of true data corresponding to a subset of the plurality of true data prepared in advance and the plurality of false data corresponding to a subset of the second number of false data, calculating the distance between the output value for true data and the output value for false data, and calculating gradient information for each weight of the generation model, so as to decrease the distance by a predetermined amount, and
updating the generation model by updating the individual weights of the generation model based on the gradient information according to the individual weights.

12-15. (canceled)
